(19) United States
(12) Patent Application Publication
(10) Pub. No.: US 2013/0159991 A1
(43) Pub. Date: Jun. 20, 2013

(54) IMAGE PROCESSING APPARATUS, SERVER APPARATUS, INFORMATION PROCESSING METHOD AND PROGRAM THEREFOR

(71) Applicant: Canon Kabushiki Kaisha, Tokyo (JP)

(72) Inventor: Kei Sato, Yokohama-shi (JP)

(73) Assignee: CANON KABUSHIKI KAISHA, Tokyo (JP)

(21) Appl. No.: 13/711,842

(22) Filed: Dec. 12, 2012

(30) Foreign Application Priority Data
Dec. 20, 2011 (JP) 2011-278329

(51) Int. Cl. G06F 9/445

(52) U.S. Cl. CPC G06F 8/65
USPC 717/173

(57) ABSTRACT

An image processing apparatus comprises a notifying unit that notifies a server apparatus of update information of firmware, a receiving unit that receives necessity information indicating whether virtual config data needs to be updated from the server apparatus in accordance with update of the firmware; a firmware obtaining unit that obtains the firmware; a virtual config data obtaining unit that obtains the virtual config data from the server apparatus, when the received necessity information indicates that the virtual config data needs to be updated; an applying unit that applies the obtained firmware; and an updating unit that updates the obtained virtual config data as real config data, when the received necessity information indicates that the virtual config data needs to be updated.

### BACKGROUND OF THE INVENTION

1. Field of the Invention

The present invention relates to an image processing apparatus, a server apparatus, an information processing method and a program therefor.

2. Description of the Related Art

Some types of image forming apparatuses are configured to store config data, which is a setting value for switching an operation. When the config data for all the image forming apparatuses is to be changed, it is required to perform the setting by the number of the image forming apparatuses, because the config data is stored in a storage apparatus of each image forming apparatus. There is a technique of setting config data for a plurality of image forming apparatuses all together from a certain information processing apparatus to save time and effort. There is also a technique of performing integrated management of config data by placing the config data at a location which can be referenced from the network so that the plurality of image forming apparatuses can reference the same config data (Japanese Patent Application Laid-Open No. 2007-130838).

Further, if the configuration of config data changes as the firmware for controlling the image forming apparatus is updated, the config data needs to be converted. In order to save time and effort, there is a technique of converting config data by delivering a program for converting the setting to the image forming apparatus (Japanese Patent Application Laid-Open No. 2009-164902).

Since integrated management of config data at the time of firmware update is not taken into consideration in the prior art, update of the firmware and synchronization of the config data need to be performed separately, which causes a problem of taking time in completing the whole process.

### SUMMARY OF THE INVENTION

The present invention is made in view of these problems and has an object of reducing the processing time of updating the firmware.

In view of the foregoing problems, the present invention provides with an image processing apparatus that comprises a notifying unit that notifies a server apparatus of update information of firmware, a receiving unit that receives necessity information indicating whether virtual config data needs to be updated from the server apparatus in accordance with update of the firmware; a firmware obtaining unit that obtains the firmware; a virtual config data obtaining unit that obtains the virtual config data from the server apparatus, when the received necessity information indicates that the virtual config data needs to be updated; an applying unit that applies the obtained firmware; and an updating unit that updates the obtained virtual config data as real config data, when the received necessity information indicates that the virtual config data needs to be updated.

According to the present invention, the processing time of updating the firmware can be reduced.

Further features of the present invention will become apparent from the following description of exemplary embodiments with reference to the attached drawings.

### BRIEF DESCRIPTION OF THE DRAWINGS

FIG. 1 is a diagram illustrating an example of system configuration for a system of the present embodiment.

FIG. 2 is a diagram illustrating an example of hardware configuration of each apparatus included in the system of the present embodiment.

FIG. 3 is a diagram illustrating an example of software configuration of each apparatus included in the system of the present embodiment.

FIG. 4A is a diagram illustrating an example of device configuration data of a device identifier 010001 without a facsimile unit.

FIG. 4B is a diagram illustrating an example of device configuration data of the device identifier 010001 with a facsimile unit.

FIG. 4C is a diagram illustrating an example of device configuration data of a device identifier 020001.

FIG. 5A is a diagram illustrating an example of real config data before firmware update.

FIG. 5B is a diagram illustrating an example of real config data with the configuration changed after the firmware update.

FIG. 6 is a diagram illustrating an example of new config data.

FIG. 7 is a diagram illustrating an example of virtual device.

FIG. 8A is a diagram illustrating an example of setting value schema for each model of a model code 0x01.

FIG. 8B is a diagram illustrating an example of setting value schema for each model of a model code 0x02.

FIG. 9 is a diagram illustrating an example of config data for tenant.

FIG. 10A is a diagram illustrating an example of virtual config data for an image forming apparatus of a device identifier 010001.

FIG. 10B is a diagram illustrating an example of virtual config data for the image forming apparatus of a device identifier 010002.

FIG. 10C is a diagram illustrating an example of virtual config data for the image forming apparatus of a device identifier 020001.

FIG. 11 is a diagram illustrating an example of information on firmware.

FIG. 12 is a diagram illustrating an example of information on firmware delivery.

FIG. 13 is a flow chart for describing a process performed by an administrator user to update config data for tenant with a terminal apparatus.

FIG. 14 is a flow chart for describing a process of obtaining virtual config data from the image forming apparatus.

FIG. 15 is a flow chart for describing a process of updating real config data of the image forming apparatus at the time of firmware update.

FIG. 16 is a diagram illustrating an example of screen for receiving a firmware update instruction.

### DESCRIPTION OF THE EMBODIMENTS

Preferred embodiments of the present invention will now be described in detail in accordance with the accompanying drawings.

### Embodiment 1

At first, terms are defined.

Config data is data for switching the operation of an image forming apparatus. An example of config data may be a default value for imposition in a copy job. If the config data is set to “1 in 1”, one page is printed on a sheet of paper as a result of copying. If the config data is set to “2 in 1”, two pages are printed on a sheet of paper as a result of copying. Device configuration data is data indicating configuration of devices in an image forming apparatus. An example of device configuration data may be data showing whether the apparatus has a facsimile unit. The examples of device configuration data further include a unique model code for identifying the model of the image forming apparatus and the firmware version in operation.

A setting value schema for each model is data defining the schema of the config data held by a specific model of the image forming apparatus. The schema is data defining the rules for and the positioning of the config data. For example, the setting value identifier, the default value, the range, and a condition for validating data for each config data are included in the setting value schema for each model. In operation of the present embodiment, it is assumed that each model holds different config data, and therefore, the setting value schema is prepared for each model.

A virtual device is a group of data of real devices held by a group of server computers. More specifically, the virtual device includes at least the device configuration data and the config data.

A tenant is a unit of entruster who entrusts the management of the image forming apparatuses. A tenant identifier is a unique identifier for identifying the tenant. Assuming that a corporation entrusts the management of the image forming apparatuses 101A, 101B and 101C in a user environment 100. In that case, a corresponding tenant identifier is assigned to the user environment 100 so that the image forming apparatuses 101A, 101B and 101C are recognized and managed as the image forming apparatuses belonging to the tenant.

The data included in the virtual device, the data held by the real device and the data dedicated to the tenant will be defined as below to distinguish from each other.

The device configuration data included in the virtual device will be called virtual device configuration data and the config data included in the virtual device will be called virtual config data.

The device configuration data held by the real device will be called real device configuration data and the config data held by the real device will be called real config data.

The config data which is desired to be used in common in the tenant will be called config data for tenant.

The terms will be used as described above. Terms other than those described above will be described as required.

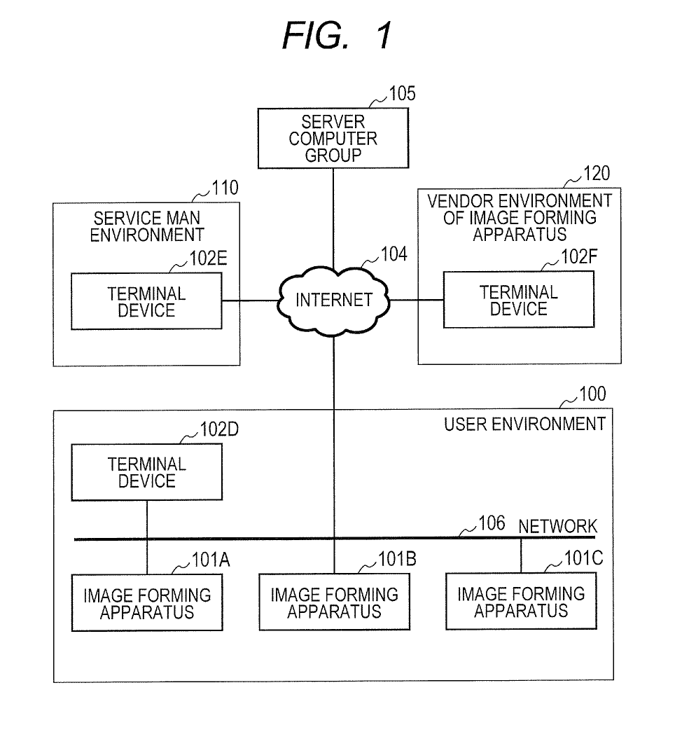

FIG. 1 is a diagram illustrating an example of system configuration for a system of the present embodiment.

The image forming apparatuses 101A, 101B and 101C are the image forming apparatuses to be managed. The image forming apparatuses 101A, 101B and 101C can access the Internet 104 via a network 106. The image forming apparatus is an example of the image processing apparatus.

A terminal apparatus 102D is a computer which can be operated by a user of the user environment 100 and can access the Internet 104 via the network 106.

The terminal apparatus 102E is a computer which can be operated by a service man who manages the image forming apparatuses 101A, 101B and 101C and can access the Internet 104.

The terminal apparatus 102F is a computer which can be operated by a person responsible for management who belongs to the vendor of the image forming apparatuses and can access the Internet 104.

The Internet 104 is a network which enables digital communication on the public network.

A group of server computers 105 is a group of servers that provides services via the Internet 104. The group of server computers 105 may include a plurality of server computers or a single server computer. In the description below, it is assumed that the group of server computers 105 includes a plurality of server computers. The group of server computers 105 is an example of the server apparatus.

The network 106 is a network which enables digital communication in the user environment 100.

A service man environment 110 is the environment in which a service man manages the image forming apparatuses by using the terminal apparatus 102E.

A vendor environment 120 of the image forming apparatuses is the environment in which a person responsible for management of the vendor who produced the image forming apparatuses performs data maintenance required for managing the image forming apparatuses by using the terminal apparatus 102F.

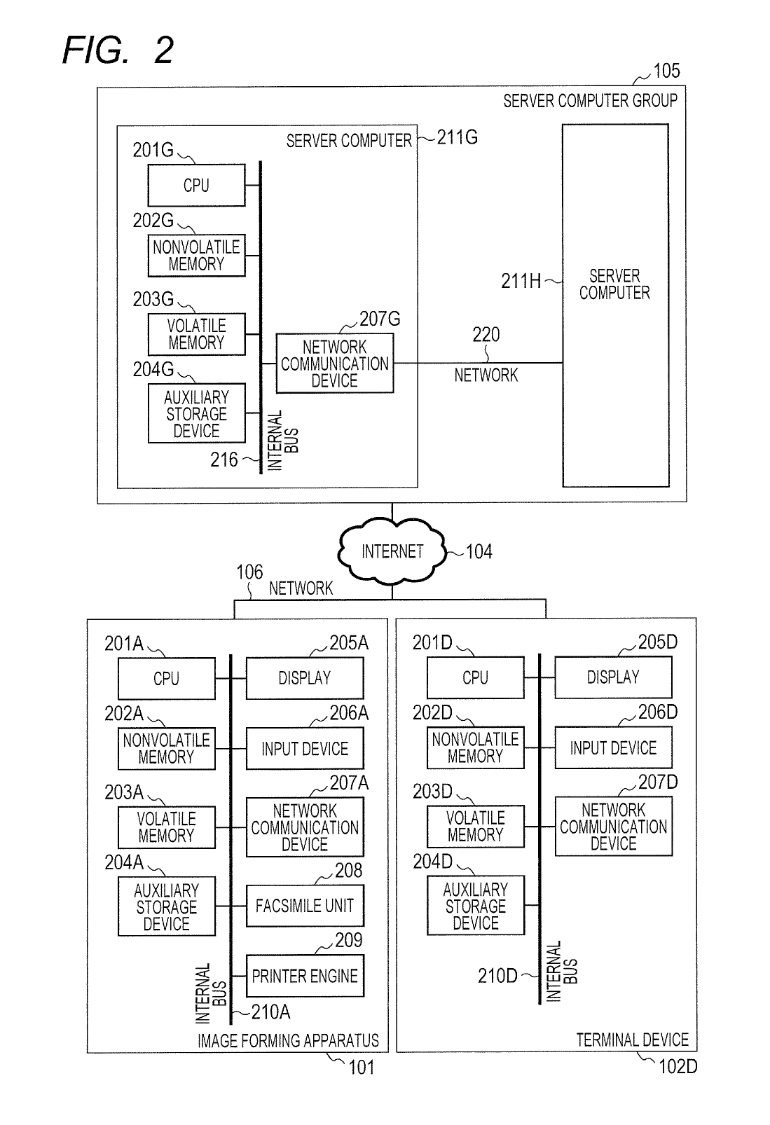

FIG. 2 is a diagram illustrating an example of hardware configuration of each apparatus included in the system of the present embodiment.

A CPU 201 executes a program and controls various types of processes.

A nonvolatile memory 202 includes a ROM and stores a program and data required for the initial stage of starting of the apparatus.

A nonvolatile memory 202A is divided into two storage areas of a first area which stores firmware and data for controlling the image forming apparatus 101 and firmware for updating, and a second area which stores a program for updating firmware.

A volatile memory 203 includes a RAM and is used as temporary storage location for programs and data.

An auxiliary storage apparatus 204 includes a large capacity storage apparatus such as a hard disk and a RAM drive, and saves bulk data and holds executable codes of programs. As compared with the volatile memory 203, the auxiliary storage apparatus 204 stores data that is needed to be held for a long time. Since the auxiliary storage apparatus 204 is a nonvolatile storage apparatus, the auxiliary storage apparatus 204 can keep storing the data even after the power is turned off.

A display 205 is an apparatus for conveying information to a utilizer. The utilizer herein means the user and the service man.

An input apparatus 206 is an apparatus for receiving a selecting instruction from the utilizer and conveying the instruction to the program via an internal bus 210.

A network communication apparatus 207 is an apparatus for communicating with another information processing apparatus via the network.

A facsimile unit 208 is a hardware unit for transmitting one of image data formed by the image forming apparatus 101 and image data stored in the auxiliary storage apparatus to another information processing apparatus via the network 106. The facsimile unit is optional and may not be mounted to some apparatuses.

A printer engine 209 prints one of image data formed by the image forming apparatus 101 and image data stored in the auxiliary storage apparatus on a paper medium.

The internal bus 210 is a communication bus for connecting the CPU 201, the nonvolatile memory 202, the volatile memory 203, the auxiliary storage apparatus 204, the display 205, the input apparatus 206 and the network communication apparatus 207 to one another for communication in the image forming apparatus 101.

The server computer 211 is one of the plurality of server computers which make up the group of server computers 105.

The internal bus 216 is a communication bus for connecting the CPU 201, the nonvolatile memory 202, the volatile memory 203, the auxiliary storage apparatus 204 and the network communication apparatus 207 of the server computer 211 to one another for communication in the server computer 211.

The network 220 is a network for enabling high-speed communication among the server computers 211 which make up the group of server computers 105.

The software configuration of the server computer 211G, the group of server computers 105 or the like is realized by the CPU 201G executing the process based on the program stored in the storage apparatus such as the auxiliary storage apparatus 204G. That is, when the CPU 201G executes the process based on the program stored in the storage apparatus such as the auxiliary storage apparatus 204G, the process according to the flow chart for the server computer 211G, the group of server computers 105 or the like to be described later is realized.

Similarly, the software configuration of the image forming apparatus 101 is realized by the CPU 201A executing the process based on the program stored in the storage apparatus such as the auxiliary storage apparatus 204A. That is, when the CPU 201A executes the process based on the program stored in the storage apparatus such as the auxiliary storage apparatus 204A, the process according to the flow chart for the image forming apparatus 101 or the like to be described later is realized.

Similarly, the software configuration of the terminal apparatus 102D is realized by the CPU 201D executing the process based on the program stored in the storage apparatus such as the auxiliary storage apparatus 204D. That is, when the CPU 201D executes the process based on the program stored in the storage apparatus such as the auxiliary storage apparatus 204D, the process according to the flow chart for the terminal apparatus 102D to be described later is realized.

FIG. 3 is a diagram illustrating an example of software configuration of each apparatus included in the system of the present embodiment.

At first, functions (respective sections) of the image forming apparatus 101 will be described.

A real config data holding section 301 holds the config data. The config data is configured in the auxiliary storage apparatus 204A. The image forming apparatus switches behavior of the operation based on the real config data held by the real config data holding section 301.

A real config data updating section 302 updates the real config data held by the real config data holding section 301. The real config data is updated by using the virtual config data receive by a virtual config data receiving section 303 to be described later. The real config data is updated only on the condition that the virtual config data is updated according to a virtual config data update confirming section 322 to be described later.

The virtual config data receiving section 303 invokes a virtual config data obtaining section 320 to be described later to receive the virtual config data. An address held in the real config data holding section 301 is used as an address for invoking the virtual config data obtaining section 320. More specifically, in the example of FIG. 10A to be described later, the address is “http:/CanonComConfig” in which the setting value identifier 702 is a value 703 of “device_settings.cloud_address.”

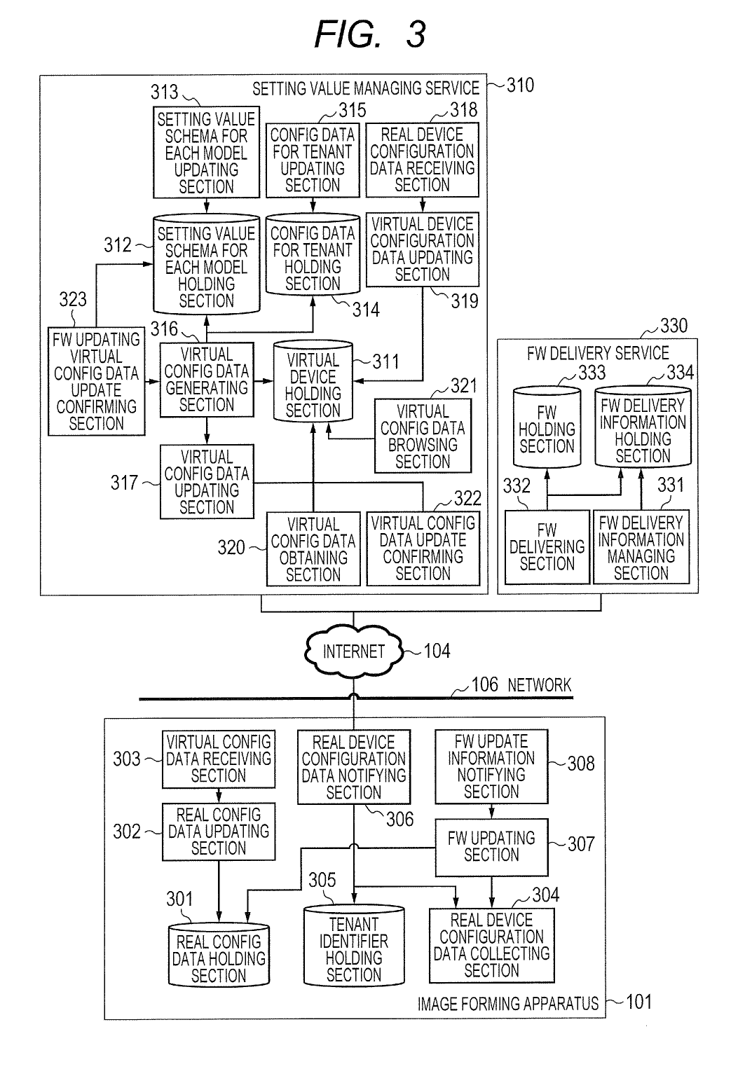

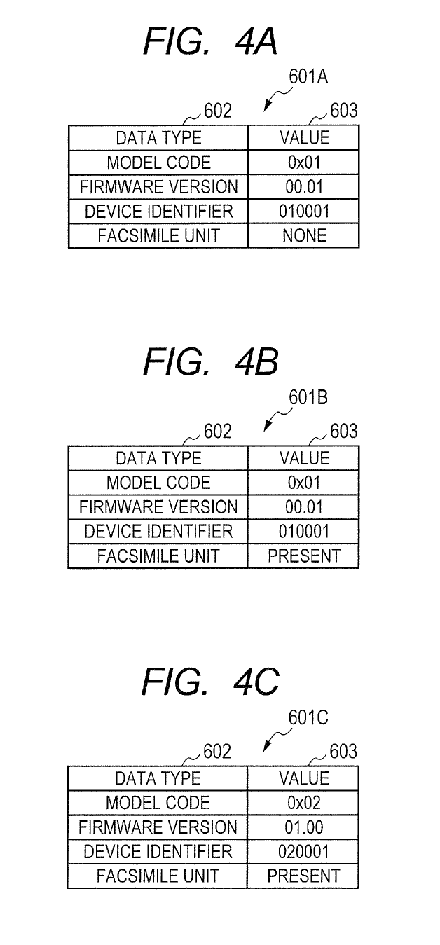

The real device configuration data collecting section 304 collects the device configuration data of the image forming apparatus 101. FIGS. 4A to 4C are diagrams illustrating an example of the real device configuration data. A value 603 is stored for each data type 602. The device configuration data includes the model code for identifying the model, the firmware version, the device identifier for identifying the device and presence/absence of the facsimile unit. FIGS. 4A, 4B and 4C are examples of the device configuration data, respectively.

The tenant identifier holding section 305 stores the tenant identifier to which the image forming apparatus 101 belongs. The tenant identifier is set at the initialization of the image forming apparatus 101 and stored in the auxiliary storage apparatus 204A so as not to be lost even if the power is turned off.

The real device configuration data notifying section 306 notifies the real device configuration data collected by the real device configuration data collecting section 304 together with the tenant identifier stored by the tenant identifier holding section 305. The destination of the notification is a real device configuration data receiving section 318 to be described later.

An FW updating section 307 updates firmware which controls the image forming apparatus 101. The FW updating section 307 is realized by both of the firmware stored in the first area of the nonvolatile memory 202 and controlling the image forming apparatus 101 (hereinafter, referred to as current firmware) and an update program stored in the second area.

A flow of firmware update performed by the FW updating section 307 is shown below.

The firmware update is performed by switching two modes of the normal mode and the firmware updating mode. The normal mode is a mode of controlling the image forming apparatus 101 by the current firmware stored in the first area of the nonvolatile memory 202A. The firmware updating mode is a mode of updating the current firmware by the update program stored in the second area.

First, the FW updating section 307 receives a firmware update instruction from the user via the display 205A at starting of the normal mode. According to the received instruction, the FW updating section 307 downloads (obtains) the firmware (hereinafter, referred to as update firmware) from an FW delivery service 330 to be described later and stores the firmware in the first area of the nonvolatile memory 202A. Subsequently, the FW updating section 307 restarts the image forming apparatus 101 in the firmware updating mode.

Next, the FW updating section 307 overwrites the current firmware with the update firmware at starting of the firmware updating mode. Subsequently, the FW updating section 307 restarts the image forming apparatus 101 in the normal mode. The image forming apparatus 101 after the restart is controlled by the update firmware.

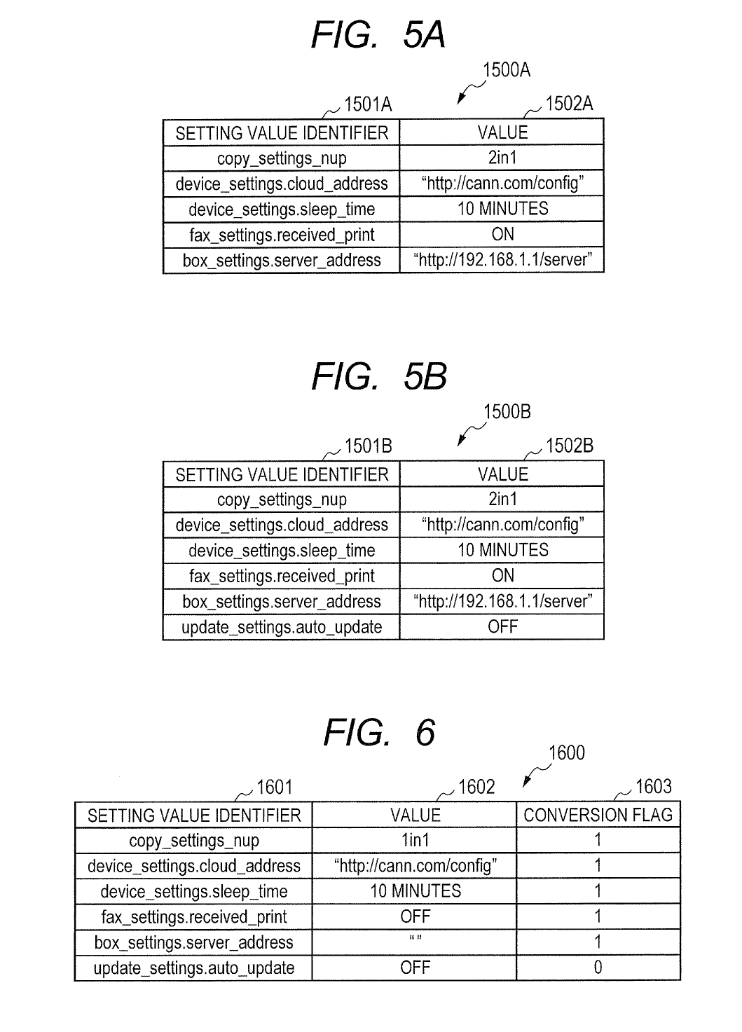

If the configuration of the real config data changes according to the firmware update, data is converted by using the config data of a new configuration (hereinafter, referred to as new config data) included in the update firmware. Hereinafter, the real config data before the update is referred to as old config data. Examples of the real config data are illustrated in FIGS. 5A and 5B. FIG. 5A is the real config data before the firmware update. Similarly, FIG. 5B is the real config data with the configuration changed after the firmware update. Examples of the new config data are illustrated in FIG. 6.

When the firmware is updated, the conversion process from the old config data to the new config data is performed. A flow of the conversion process will be described below with reference to FIGS. 5A, 5B and 6.

Whether the values are to be taken over from the old config data is previously specified in each setting of the new config data in the form of a conversion flag 1603. If the setting of the new config data is specified to take over the value (if the value of the conversion flag 1603 is 1), the update is performed with the same setting value as in the old config data. In the examples of FIGS. 5A, 5B and 6, since the value of the conversion flag for copy_settings.nup in FIG. 6 is 1, the value in FIG. 5A, 2 in 1, is taken over in FIG. 5B. On the other hand, if the setting of the new config data is specified not to take over the value (if the value of the conversion flag 1603 is 0), the default value previously defined for the new config data is used as it is. In the examples of FIGS. 5A, 5B and 6, since the conversion flag for update_settingsAuto_updatep in FIG. 6 is 0, the value in FIG. 6, OFF, is taken over in FIG. 5B.

The conversion process enables the real config data updating section 302 to update the real config data with the same process as in the case where the configuration of config data does not change, even if the configuration of the real config data changes according to the firmware update.

The FW update information notifying section 308 notifies an FW updating virtual config data update confirming section 323 and an FW delivery information managing section 331, to be described later, of information on the firmware update instruction and the firmware version. The information received from the user by the FW updating section 307 is used as the information on the firmware update instruction, and the version collected by the real device configuration data collecting section 304 is used as the version.

Now, the sections of a setting value managing service 310 will be described.

The setting value managing service 310 is a service for providing functions of managing the config data of the image forming apparatus. The setting value managing service 310 is provided on the above described group of server computers 105. The setting value managing service 310 holds a plurality of functions (respective sections), which will be described below.

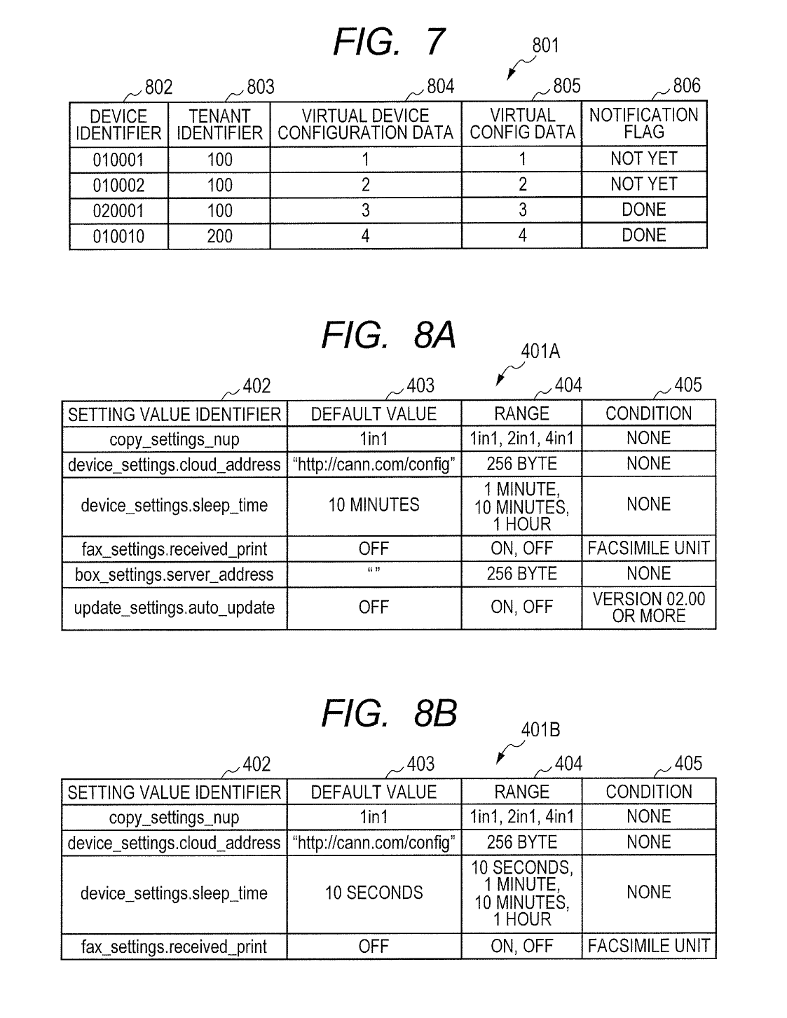

The virtual device holding section 311 stores data that is held by the virtual device. Examples of the virtual device stored by the virtual device holding section 311 are illustrated in FIG. 7.

A virtual device list 801 is the whole of the virtual devices held by the virtual device holding section 311.

The device identifier 802 is an identifier for identifying one of the plurality of the virtual devices in the virtual device list 801. The device identifier 802 is originally an identifier stored by the image forming apparatus 101 and a unique identifier which can identify the image forming apparatus 101. The device identifier 802 is notified from the image forming apparatus 101 as a piece of the device configuration data.

The tenant identifier 803 is the tenant identifier to which the image forming apparatus 101 corresponding to the virtual device belongs.

The virtual device configuration data 804 is the device configuration data for the image forming apparatus 101 corresponding to the virtual device. For the virtual device configuration data, the information illustrated in FIGS. 4A to 4C are separately held by the virtual device holding section 311. In the virtual device configuration data 804, an identifier for referencing FIGS. 4A to 4C are held.

The virtual config data 805 is the config data which is to be referenced by the image forming apparatus 101 corresponding to the virtual device. For the virtual config data, the information illustrated in FIGS. 10A to 10C is separately held by the virtual device holding section 311. In the virtual config data 805, an identifier for referencing FIGS. 10A to 10C is held.

A notification flag 806 is a flag indicating whether the update of the virtual config data is notified to the image forming apparatus 101 after the update is performed. The notification flag 806 is set to “DONE” when the corresponding virtual config data is referenced by the virtual config data obtaining section 320. The notification flag 806 is set to “NOT YET” when the corresponding virtual config data is updated by the virtual config data updating section 317.

A setting value schema for each model holding section 312 stores a setting value schema for each model. A setting value schema for each model is prepared correspondingly for each model of the image forming apparatus.

Examples of the setting value schema for each model are illustrated in FIGS. 8A and 8B.

FIG. 8A is an example of the setting value schema for each model of the model code 0x01. FIG. 8B is an example of the setting value schema for each model of the model code 0x02.

A setting value identifier 402 is a unique identifier for identifying the setting value. “copy_settings.nup” indicates that it is the setting about imposition in the copy setting. If the setting value identifier 402 is the same, it is indicated that the setting value is of the same type even if the models are different.

The default value 403 is definition of a default setting value for the model.

The range 404 is the definition of the scope of values which can be set for the model. The range 404 for “copy_settings.nup” indicates that the value can be selected from the three types of “1 in 1, 2 in 1 and 4 in 1”.

The condition 405 is definition of a necessary condition for using the setting value in the model. Since “facsimile unit” is set to the condition 405 for “fax_settings.received_print”, it is indicated that the setting value is valid only in the case where the facsimile unit is confirmed to be mounted.

Since “version 02.00 or more” is set to the condition 405 for “update_settings.auto_update”, it is indicated that the setting value is valid only in the case where the firmware version is confirmed to be 02.00 or more. With the condition, an unnecessary setting value can be prevented from being used in the case where the configuration of the setting value is different for each firmware version.

A setting value schema for each model updating section 313 updates a setting value schema for each model held by the setting value schema for each model holding section 312. When the vendor of the image forming apparatus releases a new model, a setting value schema for each model corresponding to the new model is registered according to an instruction issued by the person responsible for management of the vendor. When the setting value is changed, the setting value schema for each model is also updated.

A config data for tenant holding section 314 holds the config data which the tenant desires to set to the image forming apparatus held by the tenant.

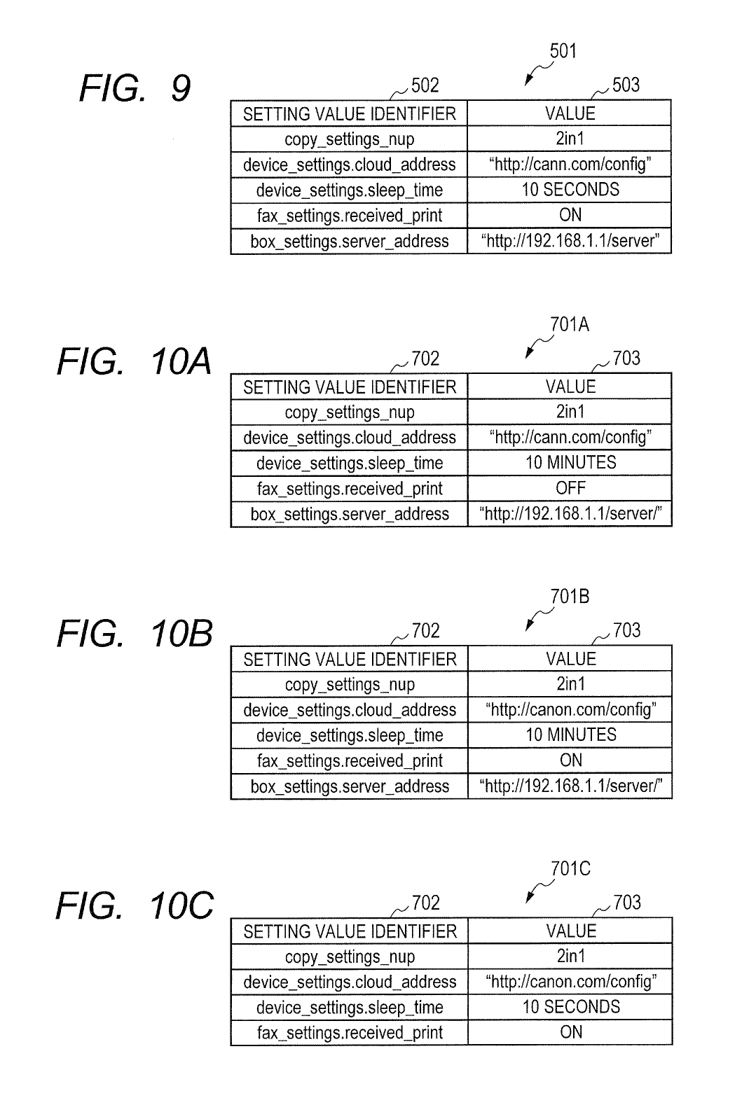

Examples of the config data for tenant are illustrated in FIG. 9.

The setting value identifier 502 is equivalent to the setting value identifier 402 in the setting value schema for each model described in FIGS. 8A and 8B.

The value 503 is a value of common setting desired by the tenant. To “copy_settings.nup”, “2 in 1” is set, which indicates that the tenant desires to set “2 in 1” for all the image forming apparatuses held by the tenant.

A config data for tenant updating section 315 updates the config data for tenant held by the config data for tenant holding section 314. The config data for tenant is updated by the service man who manages the image forming apparatus held by the tenant. The update instruction is issued from the setting screen displayed on the Web browser operating on the terminal apparatus 102E in the service man environment 110.

A virtual config data generating section 316 generates the virtual config data by using the setting value schema for each model, the config data for tenant and the virtual device configuration data. The process will be described for each step.

At first, the virtual config data generating section 316 obtains the virtual device configuration data from the virtual device holding section 311. The virtual config data generating section 316 identifies the model of the image forming apparatus by referencing the model code included in the obtained virtual device configuration data. In the example of FIG. 4A, the virtual config data generating section 316 determines that the image forming apparatus is of the model of the model code 0x01.

Next, from the setting value schema for each model holding section 312, the virtual config data generating section 316 obtains the setting value schema for each model which corresponds to the obtained model code. In the example of FIG. 4A, the virtual config data generating section 316 obtains FIG. 8A, the model code of which agrees with 0x01.

Next, the virtual config data generating section 316 takes the setting value which is defined for the setting value schema for each model as the basis for the virtual config data. In the example of FIG. 8A, the six setting values below are taken as the bases: “copy_settings.nup”, “device_settings.cloud_address”, “device_settings.sleep_time”, “fax_settings.received_print”, “box_settings.server_address” and “update_settings.auto_update”.

Next, the virtual config data generating section 316 obtains the value registered in the config data for tenant and determines whether the value falls within the range defined for the setting value schema for each model. In the examples of FIGS. 8A and 9, since “copy_settings.nup” is “2 in 1” and the range is “1 in 1, 2 in 1, 4 in 1”, the value falls within the range. On the other hand, since “device_settings.sleep_time” is “10 seconds” and the range is “1 minute, 10 minutes, 1 hour”, the value does not fall within the range. If the value does not fall within the range, the virtual config data generating section 316 obtains the default value which is defined for the setting value schema for each model. In this example, the default value is “10 minutes”.

Next, the virtual config data generating section 316 determines whether the condition which is defined for the setting value schema for each model is met. The virtual config data generating section 316 performs the determination by using the device configuration data. In the example of FIG. 8A, since “copy_settings.nup” does not have a condition in particular, the condition for “copy_settings.nup” is met. On the other hand, since “fax_settings.received_print” has a condition “facsimile unit” but the device configuration data is “NONE”, the condition is not met. If the condition is met, the virtual config data generating section 316 uses the value which is decided through the processing performed above. If the condition is not met, the virtual config data generating section 316 obtains the default value 403 which is defined for the setting value schema for each model. In this example, the default value is “OFF”.

If a condition is related to the firmware version as in the case of “update_settings.auto_update” but the condition is not met, the virtual config data generating section 316 does not include the setting into the virtual config data. In the examples of FIGS. 8A and 9, since the condition for “update_settings.auto_update” is “version 02.00 or more” and the device configuration data is “00.01”, the condition is not met.

Therefore, the virtual config data generating section 316 does not include the setting of “update_settings.auto_update” into the virtual config data of FIG. 9.

The value which is decided through the processing performed above is the virtual config data. Examples of the virtual config data are illustrated in FIGS. 10A to 10C. FIG. 10A is the virtual config data for the image forming apparatus of the device identifier 010001. Similarly, FIG. 10B is the virtual config data for the image forming apparatus of the device identifier 010002. FIG. 10C is the virtual config data for the image forming apparatus of the device identifier 020001.

The virtual config data updating section 317 registers the virtual config data generated by the virtual config data generating section 316 in the virtual device holding section 311. The virtual config data updating section 317 searches the virtual devices held by the virtual device holding section 311 for the virtual device, the device identifier of which agrees, and updates the virtual config data. Further, if the notification flag 806 for the virtual device is “DONE”, the virtual config data updating section 317 sets the flag to “NOT YET”. The flag indicates that the virtual config data is changed and the image forming apparatus needs to reference the new virtual config data.

The real device configuration data receiving section 318 receives notification from the real device configuration data notifying section 306. The notified information is the device configuration data illustrated in FIGS. 4A to 4C and the tenant identifier.

The virtual device configuration data updating section 319 registers the device configuration data received by the real device configuration data receiving section 318 in the corresponding virtual device as the virtual device configuration data. The virtual device configuration data updating section 319 searches the virtual devices held by the virtual device holding section 311 for the virtual device, the device identifier of which agrees, and updates the virtual device configuration data.

The virtual config data obtaining section 320 receives a request via the Internet 104 and obtains the virtual config data. The request includes at least a device identifier for identifying the virtual device. The virtual config data obtaining section 320 searches for the virtual device, the device identifier of which agrees. The virtual config data obtaining section 320 searches the virtual config data held by the searched virtual device and passes the virtual config data to the requestor.

A virtual config data browsing section 321 receives a request via the Internet 104 and browses the virtual config data. The request is a request on the HTTP protocol. The virtual config data browsing section 321 browses the virtual config data on the HTML page generated by the virtual config data browsing section 321.

The virtual config data update confirming section 322 confirms whether the virtual config data is updated. The virtual config data receiving section 303 sends a device identifier to the virtual config data update confirming section 322 via the Internet 104. The virtual config data update confirming section 322 searches the virtual devices held by the virtual device holding section 311 for the virtual device which agrees with the received device identifier. If the notification flag 806 for the searched virtual device is “NOT YET”, the virtual config data update confirming section 322 determines that the virtual config data is updated. In contrast, if the notification flag 806 is “DONE”, the virtual config data update confirming section 322 determines that the virtual config data is not updated.

Based on the information received from the image forming apparatus 101, the FW updating virtual config data update confirming section 323 confirms whether the virtual config data needs to be updated according to the firmware update. The FW updating virtual config data update confirming section 323 receives information on the firmware update sent from the FW update information notifying section 308 via the Internet 104. The notified information is the device identifier, the firmware version of the image forming apparatus 101 (hereinafter, referred to as current version), and the firmware version to be updated (hereinafter, referred to as updated version).

The processing to confirm whether the virtual config data needs to be updated will be described below for each step.

At first, the FW updating virtual config data update confirming section 323 obtains the virtual device configuration data which agrees with the device identifier from the virtual device holding section 311.

Next, the FW updating virtual config data update confirming section 323 identifies the model of the image forming apparatus by referencing the model code included in the obtained virtual device configuration data. In the example of FIG. 4A, the FW updating virtual config data update confirming section 323 identifies that the image forming apparatus is of the model of the model code 0x01.

Next, the FW updating virtual config data update confirming section 323 obtains the setting value schema for each model which corresponds to the identified model code from the setting value schema for each model holding section 312. In the example of FIG. 4A, the FW updating virtual config data update confirming section 323 obtains FIG. 8A, the model code of which agrees with 0x01. Next, the FW updating virtual config data update confirming section 323 searches the conditions 405 of FIG. 8A for the setting item which is the condition concerning the firmware version but is not met by the current version. If the corresponding setting items are present from the search, the FW updating virtual config data update confirming section 323 further searches the corresponding setting items for the setting item, the condition of which is met by the version after the firmware update. Since the searched setting items are the setting items to be increased according to the firmware update, the virtual config data needs to be updated. If the corresponding setting item is not present from the search, the virtual config data needs not to be updated.

In addition, the FW updating virtual config data update confirming section 323 searches the conditions 405 of FIG. 8A for the setting item which is the condition concerning the firmware version and is met by the current version. If the corresponding setting items are present from the search, the FW updating virtual config data update confirming section 323 further searches the corresponding setting items for the setting item, the condition of which is not met by the version after the firmware update. Since the searched setting items are the setting items to be reduced according to the firmware update, the virtual config data needs to be updated if the corresponding setting item is present. If the corresponding setting item is not present from the search, the virtual config data needs not to be updated.

The FW updating virtual config data update confirming section 323 determines that the virtual config data needs to be updated if the setting item is increased or reduced according to the firmware update. If the setting item is neither increased nor reduced, the FW updating virtual config data update confirming section 323 determines that the virtual config data needs not to be updated.

Next, functions (respective sections) of the FW delivery service 330 will be described.

The FW delivery service 330 is a service for providing functions of delivering the firmware of the image forming apparatus. The FW delivery service 330 is provided on the above described group of server computers 105. The FW delivery service 330 holds a plurality of functions (respective sections), which will be described below.

The FW delivery information managing section 331 receives information on the firmware update from the image forming apparatus 101 and manages the information. The FW delivery information managing section 331 receives firmware delivery information sent from the image forming apparatus 101 via the Internet 104, and saves the firmware delivery information in an FW delivery information holding section 334 to be described later. The notified information includes the device identifier, the model code, the updated version, the delivery date and time, and the delivery status.

An FW delivering section 332 delivers the firmware of the image forming apparatus to the image forming apparatus. The FW delivering section 332 obtains the corresponding firmware from an FW holding section 333, to be described later, according to the firmware delivery information held by the FW delivery information holding section 334 and delivers the firmware to the image forming apparatus 101.

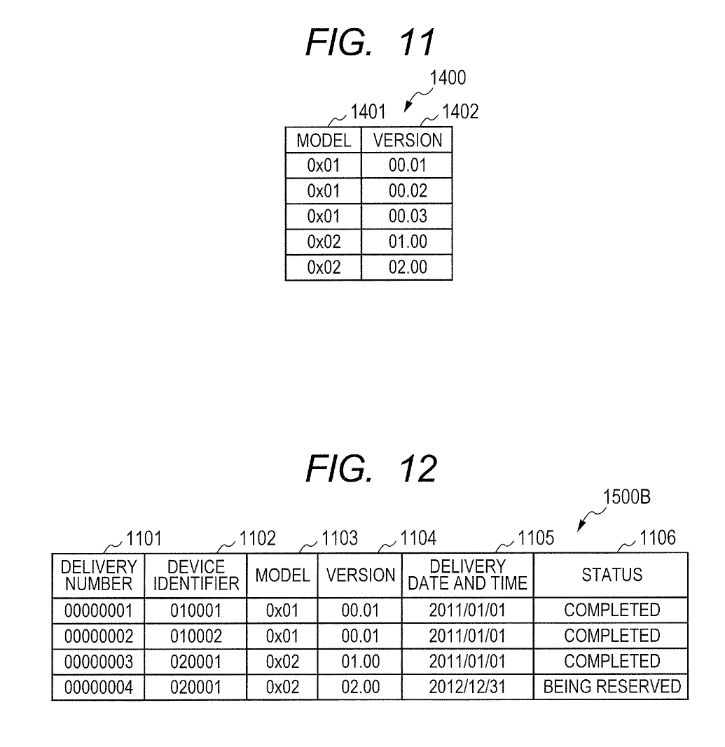

The FW holding section 333 stores information on the firmware of the image forming apparatus. FIG. 11 illustrates examples of the information on the firmware.

The firmware information 1400 includes the model code 1401 and the version 1402.

The model code 1401 indicates the model of the image forming apparatus 101 corresponding to the firmware.

The version 1402 indicates the firmware version.

The FW delivery information holding section 334 stores firmware delivery information. The FW delivery information holding section 334 stores information on the delivery of the firmware to the image forming apparatus.

FIG. 12 illustrates examples of the information on the delivery of the firmware.

FW delivery information 1100 is information on the firmware delivery based on the information notified from the image forming apparatus 101.

A delivery number 1101 is a unique number for identifying one delivery process, for which a unique value is generated by the FW delivery information managing section 331 when a new piece of delivery information is added to the FW delivery information 1100. One delivery process here means a process from reservation of the delivery through the completion of the firmware application.

The device identifier 1102 is an identifier stored by the image forming apparatus 101 as a unique identifier which can identify the image forming apparatus 101. The device identifier 1102 is notified from the image forming apparatus 101 as a piece of the firmware delivery information.

The model 1103 is a unique code for identifying the model of the image forming apparatus.

The version 1104 is the firmware version to be updated.

The delivery date and time 1105 is the date and time when the firmware is delivered.

The status 1106 is the status of the firmware delivery process indicating the process in progress at the time point. The status is divided into four phases of “being reserved”, “being delivered”, “being applied” and “completed”.

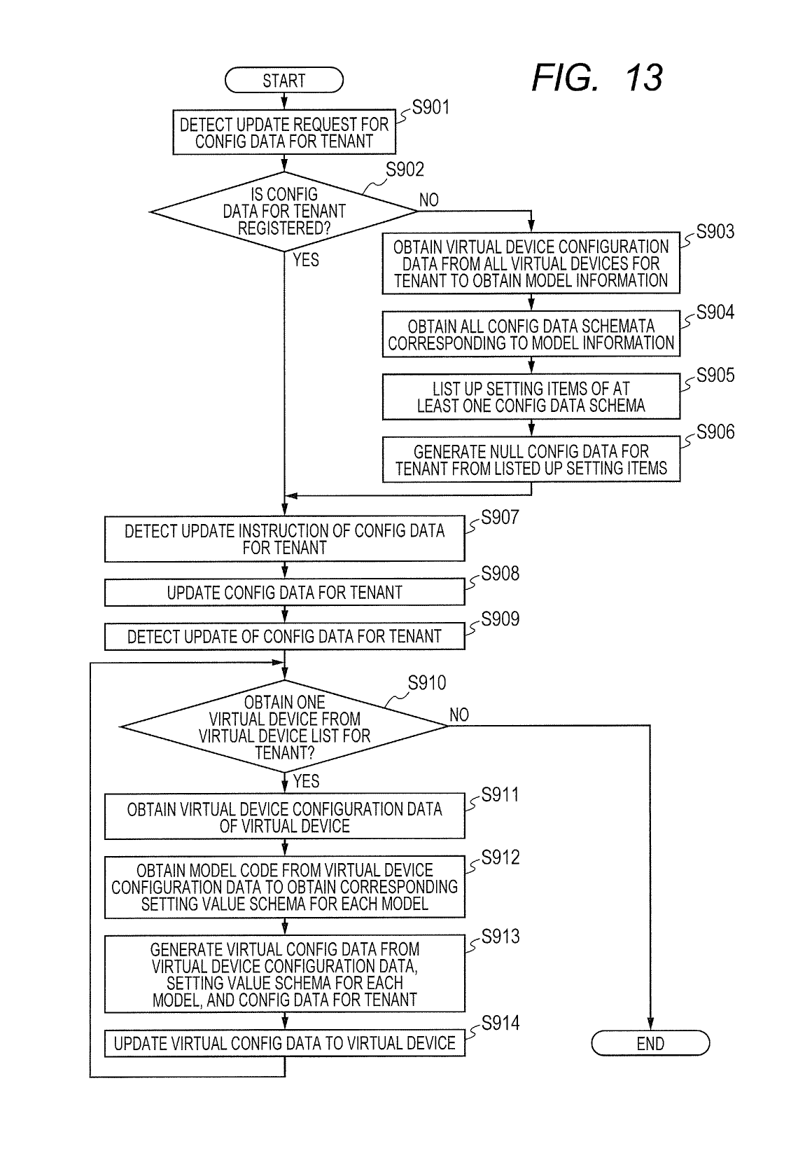

FIG. 13 is a flow chart for describing the process performed by an administrator user to update the config data for tenant with a terminal apparatus 102D.

In step S901, the config data for tenant updating section 315 detects an update request for the config data for tenant.

In step S902, the config data for tenant updating section 315 confirms whether the config data for tenant for which the update request is received in step S901 is present in the config data for tenant holding section 314. If the config data for tenant is present, the config data for tenant updating section 315 proceeds to step S907. If the config data for tenant is not present, the config data for tenant updating section 315 proceeds to step S903.

In step S903, the config data for tenant updating section 315 searches the virtual device holding section 311 for the virtual device held by the tenant.

In step S904, the config data for tenant updating section 315 references the model code included in the virtual device configuration data of the virtual device searched in step S903. Then, the config data for tenant updating section 315 searches the setting value schema for each model holding section 312 for the setting value schema for each model which corresponds to the model code.

In step S905, the config data for tenant updating section 315 lists up the setting of at least one setting value schema for each model searched in step S904.

In step S906, the config data for tenant updating section 315 generates the config data for tenant of the setting listed up in step S905.

In step S907, the config data for tenant updating section 315 detects a specific update instruction of the config data for tenant.

In step S908, the config data for tenant updating section 315 updates the config data for tenant held by the config data for tenant holding section 314 based on the update instruction detected in step S907.

In step S909, the virtual config data generating section 316 detects the update of the config data for tenant.

In step S910, the virtual config data generating section 316 searches the virtual devices held by the virtual device holding section 311 for the virtual device which corresponds to the tenant identifier of the config data for tenant, the update of which is detected. In order to sequentially perform the process on the searched virtual device, the virtual config data generating section 316 obtains a virtual device. When the virtual device is obtained, the virtual config data generating section 316 proceeds to step S911. When the process has been sequentially performed on all the virtual devices and no virtual device is obtained any more, the virtual config data generating section 316 finishes the process.

In step S911, the virtual config data generating section 316 obtains the virtual device configuration data from the virtual device.

In step S912, the virtual config data generating section 316 obtains the model code from the virtual device configuration data. Then, the virtual config data generating section 316 searches the setting value schema for each model held by the setting value schema for each model holding section 312 for the setting value schema for each model which corresponds to the model code.

In step S913, the virtual config data generating section 316 generates the virtual config data by using the virtual device configuration data, the setting value schema for each model and the config data for tenant.

In step S914, the virtual config data updating section 317 registers the virtual config data generated in step S913 in the virtual device.

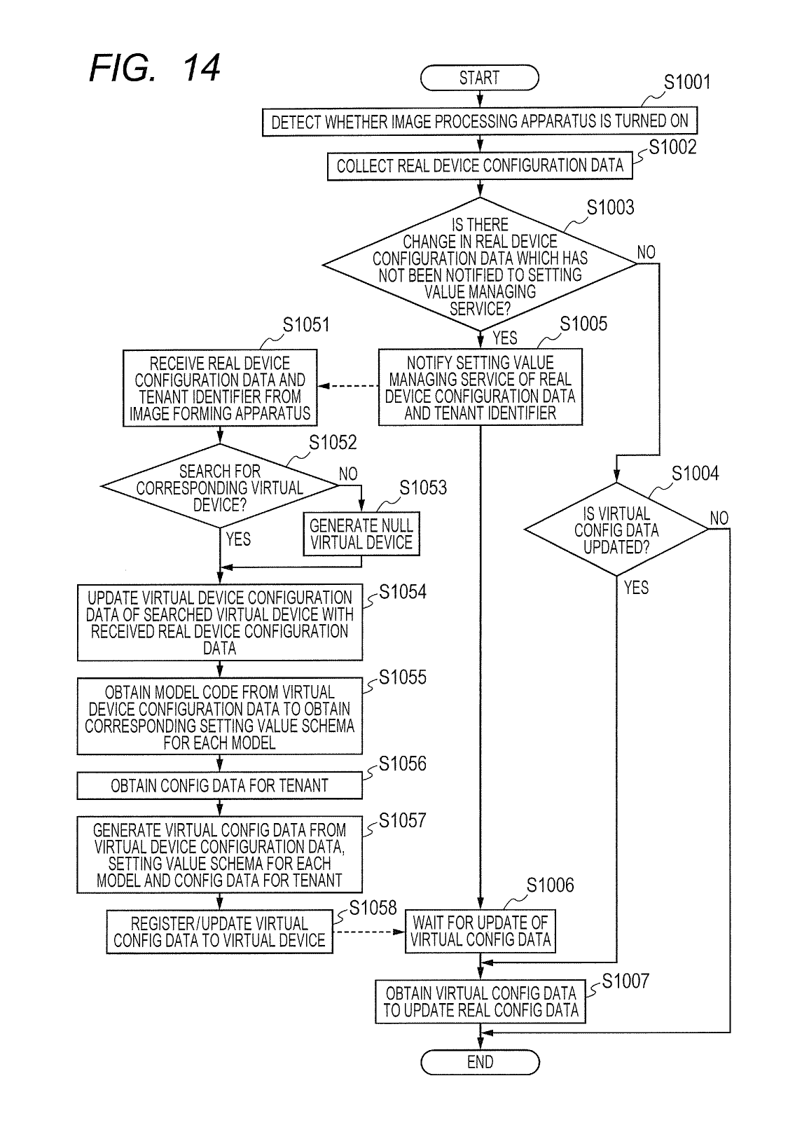

FIG. 14 is a flow chart for describing the process of obtaining the virtual config data from the image forming apparatus. Steps S1001 through S1007 are performed in the image forming apparatus. Steps S1051 through S1058 are performed in the group of server computers 105.

In step S1001, the real device configuration data notifying section 306 detects that the image processing apparatus is turned on.

In step S1002, the real device configuration data collecting section 304 collects the device configuration data.

In step S1003, by using the real device configuration data collected in step S1002, the real device configuration data notifying section 306 determines whether there is a change in the real device configuration data which has not been notified to the setting value managing service 310. If there is such a change, the real device configuration data notifying section 306 proceeds to step S1005. If there is no such a change, the real device configuration data notifying section 306 proceeds to step S1004.

In step S1004, the virtual config data receiving section 303 determines whether the device has obtained the latest virtual config data. The virtual config data receiving section 303 performs the determination by invoking the virtual config data update confirming section 322.

In step S1005, the real device configuration data notifying section 306 notifies the setting value managing service 310 of the real device configuration data and the tenant identifier. In step S1051, the setting value managing service 310 side detects the notification and performs the process, which will be described in detail later.

In step S1006, the virtual config data receiving section 303 waits to execute the process until the update of the virtual config data is completed.

In step S1007, the virtual config data receiving section 303 receives the virtual config data from the setting value managing service 310. Then, the real config data updating section 302 updates the received virtual config data as the real config data. The real config data is stored by the real config data holding section 301.

In step S1051, the real device configuration data receiving section 318 receives the real device configuration data and the tenant identifier notified from the image forming apparatus.

In step S1052, the virtual device configuration data updating section 319 searches for the virtual device corresponding to the real device configuration data and the tenant identifier received in step S1051. The virtual device configuration data updating section 319 searches the virtual devices held by the virtual device holding section 311. In the case where the image forming apparatus communicates with the setting value managing service 310 for the first time, it may be impossible to search the virtual device. If the corresponding virtual device is searched, the virtual device configuration data updating section 319 proceeds to step S1054. If the corresponding virtual device cannot be searched, the virtual device configuration data updating section 319 proceeds to step S1053.

In step S1053, the virtual device configuration data updating section 319 generates a null virtual device.

In step S1054, the virtual device configuration data updating section 319 updates the virtual device configuration data of the virtual device which is searched in step S1052 or generated in step S1053. Accordingly, the contents of the real device configuration data received in step S1051 is the new virtual device configuration data.

In step S1055, the virtual config data generating section 316 obtains the model code from the updated virtual device configuration data. Further, from the setting value schema for each model holding section 312, the virtual config data generating section 316 obtains the setting value schema for each model which corresponds to the model code.

In step S1056, the virtual config data generating section 316 obtains the config data for tenant. The virtual config data generating section 316 searches the config data for tenant held by the config data for tenant holding section 314 for the config data for tenant which corresponds to the tenant identifier.

In step S1057, the virtual config data generating section 316 generates the virtual config data. The virtual config data generating section 316 generates the virtual config data by using the virtual device configuration data, the setting value schema for each model and the config data for tenant.

In step S1058, the virtual config data updating section 317 registers the virtual config data generated in step S1057 in the corresponding virtual device.

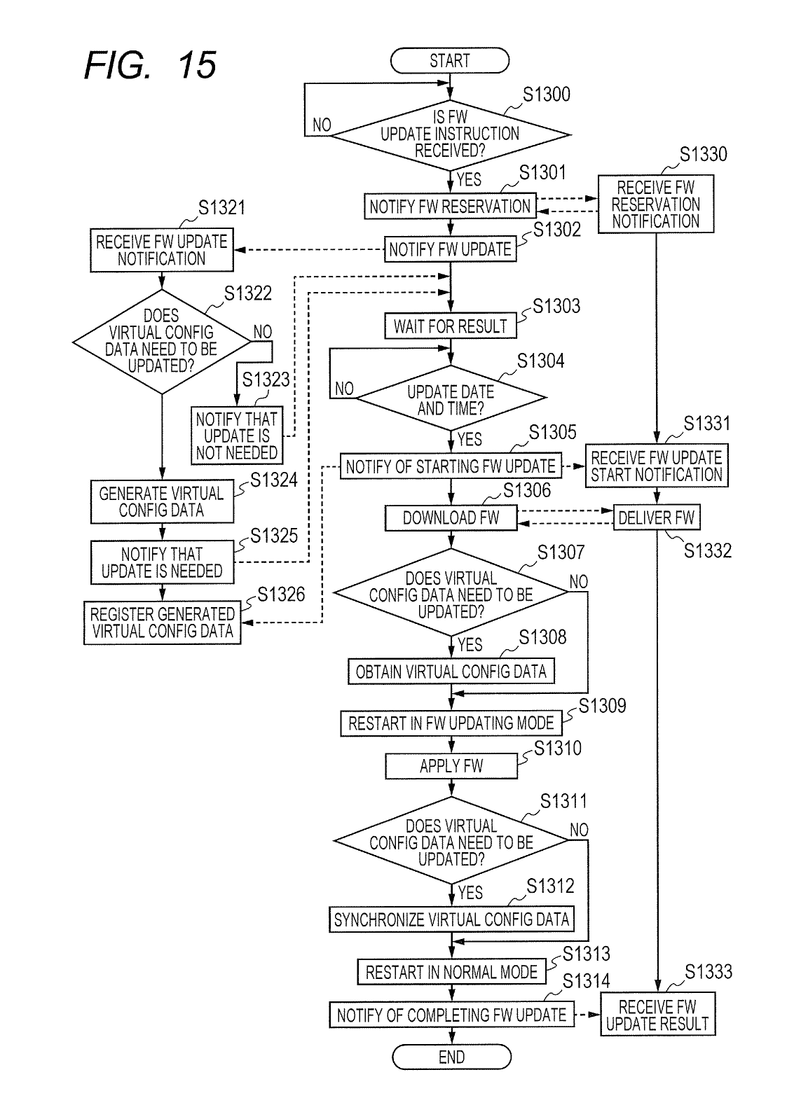

FIG. 15 is a flow chart for describing the process of updating the real config data of the image forming apparatus at the time of the firmware update. Steps S1300 through S1314 are performed in the image forming apparatus 101. Steps S1321 through S1326 and steps S1330 through S1333 are performed in the group of server computers 105.

In step S1300, the FW updating section 307 shows an FW update screen 1200 on the display 205A and receives a firmware update instruction from the user. The FW updating section 307, via the FW update screen 1200, receives the firmware version to be updated and the date and time when the firmware is updated. The received version and update date and time are saved in the nonvolatile memory 202A.

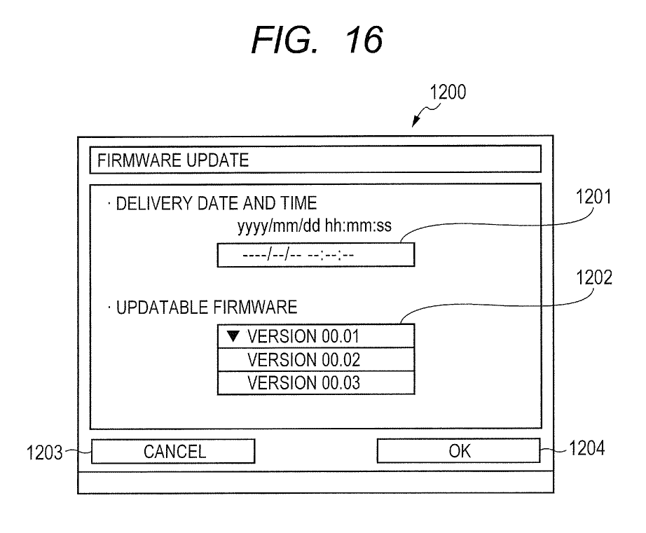

FIG. 16 is a diagram illustrating an example of screen for receiving a firmware update instruction.

The FW update screen 1200 is a screen which is shown on the display 205A by the FW updating section 307.

The delivery date and time 1201 is a field for receiving an instruction on the date and time for the image forming apparatus 101 to execute the firmware update. In the delivery date and time 1201, year, month, date, time, minute and second may be specified.

The updatable firmware 1202 is a pull-down menu for receiving an instruction on the firmware version to be updated. In order to display the FW update screen 1200, the FW updating section 307 sends the model code to the FW delivery service 330 and displays the version obtained as a response to the model code on the pull-down menu as the updatable firmware. When the FW delivery service 330 receives the model code from the image forming apparatus 101, the FW delivery service 330 searches the firmware information 1400 for the version 1402 corresponding to the model code 1401 and sends the corresponding version to the image forming apparatus 101.

The cancel 1203 is a button for cancelling the firmware update instruction. If the button is pressed, the FW updating section 307 discards the contents specified on the screen and finishes displaying the screen.

The OK 1204 is a button for confirming the firmware update instruction. If the button is pressed, the FW updating section 307 confirms the contents specified on the screen and proceeds to the next process.

In step S1301, the FW update information notifying section 308 notifies the FW delivery information managing section 331 of the device identifier, the model, the firmware version, the delivery date and time, and the status (“being reserved”). The FW update information notifying section 308 collects the device identifier and the model by using the real device configuration data collecting section 304, and uses the firmware version and the delivery date and time received in step S1300 for the firmware version and the delivery date and time. In step S1330, the FW delivery service 330 side detects the notification and performs the process, which will be described in detail later. The FW update information notifying section 308 receives the delivery number 1101 from the FW delivery information managing section 331 as a response to the notification and saves the delivery number 1101 in the nonvolatile memory 202A.

In step S1302, the FW update information notifying section 308 notifies the setting value managing service 310 of the device identifier, the firmware version of the image forming apparatus and the firmware version to be updated. The FW update information notifying section 308 collects the device identifier and the firmware version of the image forming apparatus by using the real device configuration data collecting section 304, and uses the firmware version to be updated received in step S1300 for the firmware version to be updated. In step S1321, the setting value managing service 310 side detects the notification and performs the process, which will be described in detail later.

In step S1303, the FW update information notifying section 308 waits (stands by) to execute the process until the determination on whether the virtual config data needs to be updated is completed by the setting value managing service 310. The FW update information notifying section 308 receives necessity information indicating that the update is needed or not needed from the setting value managing service 310 as the determination result. The received result is saved in the nonvolatile memory 202A.

In step S1304, the FW updating section 307 waits to execute the process until the update date and time received in step S1300 arrive. When the update date and time arrive, the FW updating section 307 proceeds to step S1305.

In step S1305, the FW updating section 307 notifies the FW delivery information managing section 331 of the start of the firmware update including the device identifier and the delivery number (update start notification). The FW updating section 307 collects the device identifier by using the real device configuration data collecting section 304, and uses the delivery number received in step S1302 for the delivery number. In step S1331, the FW delivery service 330 side detects the notification and performs the process which will be described in detail later.

In addition, the FW updating section 307 notifies the setting value managing service 310 of the device identifier. In step S1326, the setting value managing service 310 side detects the notification and performs the process which will be described in detail later.

In step S1306, the FW updating section 307 notifies the FW delivering section 332 of the delivery number 1101 and downloads the corresponding firmware (firmware obtainment). The downloaded firmware is saved in the nonvolatile memory 202A.

In step S1307, if the result received in step S1303 is that the update is needed, the FW updating section 307 proceeds to step S1308. If the result is that the update is not needed, the FW updating section 307 proceeds to step S1309.

In step S1308, the virtual config data receiving section 303 receives the virtual config data from the setting value managing service 310. The received virtual config data is saved in the nonvolatile memory 202A.

In step S1309, the FW updating section 307 restarts the image forming apparatus 101, sets the image forming apparatus 101 to start in the firmware updating mode and restarts the image forming apparatus 101.

In step S1310, after the image forming apparatus 101 is started in the firmware updating mode, the FW updating section 307 applies the firmware that was saved in the nonvolatile memory 202A in step S1306.

In step S1311, if the result received in step S1303 is that the update is needed, the FW updating section 307 proceeds to step S1312. If the result is that the update is not needed, the FW updating section 307 proceeds to step S1313.

In step S1312, the real config data updating section 302 updates the real config data held by the real config data holding section 301 by using the virtual config data saved in step S1308. Here, the process in step S1312 is the same as the process in step S1007. That is, the real config data updating section 302 updates the virtual config data that was saved in step S1308 as the real config data.

In step S1313, the FW updating section 307 restarts the image forming apparatus 101, sets the image forming apparatus 101 to start in the normal mode and restarts the image forming apparatus 101.

In step S1314, after the image forming apparatus 101 is started in the normal mode, the FW updating section 307 sends the delivery number 1101 and the status (“completed”) received in step S1301 to the FW delivery information managing section 331 and finishes the process.

In step S1330, the FW delivery information managing section 331 receives the device identifier, the model code, the firmware version to be updated, the delivery date and time, and the status (“being reserved”) as the firmware update reservation. The FW delivery information managing section 331 adds the received information to the FW delivery information 1100. The FW delivery information managing section 331 generates the delivery number 1101 for the added delivery information and adds the delivery number 1101 to the FW delivery information 1100. In addition, the FW delivery information managing section 331 sends the delivery number 1101 to the image forming apparatus 101 as a response to the FW update reservation notification.

In step S1331, the FW delivery information managing section 331 receives the delivery number 1101 and changes the status 1106 corresponding to the received delivery number 1101 to “being delivered”.

In step S1332, the FW delivering section 332 receives the delivery number 1101 from the image forming apparatus 101. The FW delivering section 332 obtains the model 1103 and the version 1104 corresponding to the received delivery number 1101 from the FW delivery information 1100, searches the firmware information 1400 for the firmware that agrees with the model 1103 and the version 1104, and sends the firmware to the image forming apparatus 101.

In step S1333, the FW delivery information managing section 331 receives the delivery number 1101 from the image forming apparatus 101. The FW delivery information managing section 331 changes the status 1106 corresponding to the received delivery number 1101 to “completed”.

In step S1321, the FW updating virtual config data update confirming section 323 receives the device identifier, the firmware version of the image forming apparatus and the firmware version to be updated sent from the image forming apparatus 101.

In step S1322, the FW updating virtual config data update confirming section 323 determines whether the virtual config data needs to be updated based on the information received in step S1321. If the update is not needed, the FW updating virtual config data update confirming section 323 proceeds to step S1323. If the update is needed, the FW updating virtual config data update confirming section 323 proceeds to step S1324.

In step S1323, the FW updating virtual config data update confirming section 323 notifies the FW update information notifying section 308 of necessity information indicating that the virtual config data needs not to be updated. In step S1303, the image forming apparatus 101 side detects the notification and performs the process.

In step S1324, the setting value managing service 310 generates the virtual config data. The process performed at this time will be described in detail below.

The setting value managing service 310 searches for the corresponding virtual device based on the device identifier received in step S1321. If the corresponding virtual device is searched, the setting value managing service 310 performs the same process as from steps S911 to S913 by using the corresponding virtual device to generate the virtual config data. If the corresponding virtual device cannot be searched, the setting value managing service 310 generates a null virtual device, and executes the same process as from steps S911 to S913 by using the generated virtual device to generate the virtual config data.

In step S1325, the FW updating virtual config data update confirming section 323 notifies the FW update information notifying section 308 of necessity information indicating that the virtual config data needs to be updated. In step S1303, the image forming apparatus 101 side detects the notification and performs the process.

In step S1326, the virtual config data updating section 317 registers the virtual config data generated in step S1325 in the corresponding virtual device as triggered by the notification from the image forming apparatus 101 in step S1305.

As described above, since the update of the firmware and the synchronization of the config data are performed at a time according to the present embodiment, the image forming apparatus 101 can be used with the integrally managed config data immediately after the firmware update.

Also, even if the config data is converted, which conventionally needs to restart the image forming apparatus 101 to validate the setting change, the image forming apparatus 101 needs not to be restarted to cause the setting value to be reflected after the firmware update.

### Embodiment 2

Now, Embodiment 2 will be described.

Although it is assumed that the setting value managing service 310 is executed in the group of server computers 105 in the network chart illustrated in FIG. 1, another configuration may be applied. For example, the group of server computers may include only a single server computer 211G. Alternatively, the group of server computers may be included in one of the user environment 100, the service man environment 110 and the vendor environment 120 of the image forming apparatus.

Although it is assumed that the service man uses the terminal apparatus 102E placed in the service man environment 110 in the network chart illustrated in FIG. 1, another configuration may be applied. For example, a configuration may be applied such that the service man uses the terminal apparatus 102D placed in the user environment 100 with permission of the user.

Although the server computers 211G and 211H communicate with each other via the network 220 in the hardware block diagram illustrated in FIG. 2, another configuration may be applied. For example, the server computers 211G and 211H may communicate with each other via the Internet 104.

Although the real config data holding section 301 stores the real config data in the auxiliary storage apparatus 204A in the software block diagram illustrated in FIG. 3, another configuration may be applied. For example, a configuration may be applied such that the real config data is temporarily stored in the volatile memory 203A. In that case, since the real config data is lost when the power is turned off, the virtual config data receiving section 303 needs to receive the virtual config data each time when the device is turned on. In a more specific processing flow, the configuration is applied such that step S1007 is always executed without requiring to determine the update of the virtual config data in step S1004 of FIG. 14.

Although the real device configuration data collecting section 304 collects the real device configuration data each time when the image forming apparatus is turned on in the software block diagram illustrated in FIG. 3, another configuration may be applied. For example, a configuration may be applied such that the real device configuration data holding section always stores the real device configuration data in the auxiliary storage apparatus 204A. In that case, the configuration needs to enable the real device configuration data held by the real device configuration data holding section to be immediately rewritten in response to a change in the real device configuration data.

Accordingly, the real device configuration data collecting section 304 needs to watch the real device configuration data for a change, and when a changed content is detected, needs to update the changed content in the real device configuration data holding section. Further, the configuration is applied such that the real device configuration data notifying section 306 requests the real device configuration data from the real device configuration data holding section.

Although the tenant identifier holding section 305 stores the tenant identifier in the auxiliary storage apparatus 204A in the software block diagram illustrated in FIG. 3, another configuration may be applied. For example, a configuration may be applied such that the user inputs the tenant identifier each time by using the input apparatus 206A. The input may be performed when the image forming apparatus is started or at another occasion. In that case, the tenant identifier is stored in the volatile memory 203A.

Although the real device configuration data notifying section 306 detects that the image forming apparatus is turned on and performs the process in the software block diagram illustrated in FIG. 3, another configuration may be applied. For example, a configuration may be applied such that the user instructs to obtain the virtual config data by using the input apparatus 206A. In that case, the configuration is applied such that detecting the instruction to obtain the virtual config data in step S1001 of FIG. 14 causes the processes of step S1002 and after to be executed.

Although the virtual device holding section 311 holds the identifiers for identifying the virtual device configuration data and the virtual config data as illustrated in FIG. 7 in the software block diagram illustrated in FIG. 3, another configuration may be applied. For example, a configuration may be applied such that the data entity is held instead of the identifier.

Although a virtual config data generating section 316 generates the virtual config data from the setting value schema for each model, the config data for tenant and the virtual device configuration data in the software block diagram illustrated in FIG. 3, another configuration may be applied. For example, a configuration may be applied such that the virtual config data generating section 316 generates the virtual config data according to each model from the two of the setting value schema for each model and the config data for tenant. In that case, the configuration is applied such that the image forming apparatus references the real config data according to the device configuration.

As another example, the image forming apparatus may be configured to generate the virtual config data by further using license data. In that case, the configuration is applied such that the image forming apparatus generates the virtual config data to match an optional function of the image forming apparatus.

Although the setting value managing service 310 and the FW delivery service 330 are different services in the software block diagram illustrated in FIG. 3, the setting value managing service 310 and the FW delivery service 330 may be the same service. For example, the setting value managing service 310 and the FW delivery service 330 may be integrated into a single service. In that case, the notification at steps S1301, S1302 and S1305 which the image forming apparatus 101 issues separately to the setting value managing service 310 and the FW delivery service 330 can be performed at a time.

Although the firmware update instruction from the user is received by the FW updating section 307 in the software block diagram illustrated in FIG. 3, another configuration may be applied. For example, the firmware update instruction from the user may be received by the FW delivery service 330.

Although if the firmware update instruction is received in step S1300, then the firmware update notification is issued in step S1302 in the sequence diagram illustrated in FIG. 15, another sequence may be applied. For example, before executing step S1302, the image forming apparatus 101 determines whether the config data is integrally managed by the setting value managing service 310. If the config data is not integrally managed as a result of the determination, the image forming apparatus 101 can reduce unnecessary notification by skipping the process in step S1302.

Although it is assumed that the date and time are specified in the firmware update instruction received in step S1300 in the sequence diagram illustrated in FIG. 15, the date and time may not be specified. For example, an instruction to immediately update the firmware may be received. In that case, a confirmation screen on whether to wait for the firmware update may be shown on the display 205A to be selected by the user until the generation of the virtual config data is completed.

Alternatively, the process of S1325 may be performed before the process of S1324 so that if the result received in step S1303 is that the update is needed, the display 205A shows as such. Then, confirmation on whether to wait for the firmware update may be shown on the display 205A to be selected by the user until the generation of the virtual config data is completed.

### Other Embodiments

The present invention is also realized by executing the process below. That is, the present invention is realized by supplying software (program) for realizing functions of the above described embodiment to one of the system and the apparatus via one of a network and various storage media so that the computer (including the CPU and the MPU) of one of the system and the apparatus reads out and executes the program.

As described above, according to the above described respective embodiments, even if different models and hardware options are included, all the config data can be integrally managed. Further, by performing the update of the firmware and the synchronization of the config data at a time, a system for integrally managing the config data efficiently can be provided.

That is, according to the above described respective embodiments, the process time of updating the firmware can be reduced.

Although exemplary embodiments of the present invention have been described in detail, the present invention is not limited to the specific embodiments, and various modifications and alterations are possible within the spirit of the present invention described in the claims.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-278329, filed Dec. 20, 2011, which is hereby incorporated by reference herein in its entirety.

What is claimed is:

1. An image processing apparatus which can communicate with a server apparatus via a network, the image processing apparatus comprising:
a notifying unit configured to notify the server apparatus of update information of firmware;
a receiving unit configured to receive necessity information indicating whether virtual config data needs to be updated from the server apparatus in accordance with update of the firmware;
a firmware obtaining unit configured to obtain the firmware;
a virtual config data obtaining unit configured to obtain the virtual config data from the server apparatus, when the necessity information received by the receiving unit indicates that the virtual config data needs to be updated;
an applying unit configured to apply the firmware obtained by the firmware obtaining unit; and
an updating unit configured to update the virtual config data obtained by the virtual config data obtaining unit as real config data, when the necessity information received by the receiving unit indicates that the virtual config data needs to be updated.

2. The image processing apparatus according to claim 1 further comprising a waiting unit configured to wait to obtain the firmware by the firmware obtaining unit until the necessity information is received by the receiving unit.

3. The image processing apparatus according to claim further comprising a displaying unit configured to display a confirmation screen on whether to wait to obtain the firmware by the firmware obtaining unit until the necessity information is received by the receiving unit.

4. The image processing apparatus according to claim further comprising a update start notification unit configured to notify the server apparatus of start of the firmware update before obtaining the firmware by the firmware obtaining unit.

5. A server apparatus which can communicate with an image processing apparatus via a network, the server apparatus comprising:
a receiving unit configured to receive update information of firmware from the image processing apparatus;
a determining unit configured to determine whether virtual config data needs to be updated based on the update information received by the receiving unit;
a generating unit configured to generate the virtual config data, when the determining unit determines that the virtual config data needs to be updated;
a notifying unit configured to notify the image processing apparatus of necessity information indicating that the virtual config data needs to be updated, when the determining unit determines that the virtual config data needs to be updated; and
a registering unit configured to register the virtual config data generated by the generating unit.

6. The server apparatus according to claim 5 wherein the registering unit registers the virtual config data generated by the generating unit, when notification of start of the firmware update is received from the image processing apparatus.

7. An information processing method carried out in an image processing apparatus which can communicate with a server apparatus via a network, the method comprising:
notifying the server apparatus of update information of firmware;
receiving necessity information indicating whether virtual config data needs to be updated from the server apparatus in accordance with update of the firmware;
obtaining the firmware;
obtaining the virtual config data from the server apparatus, when the received necessity information indicates that the virtual config data needs to be updated;
applying the obtained firmware; and
updating the obtained virtual config data as real config data, when the received necessity information indicates that the virtual config data needs to be updated.

8. An information processing method carried out in a server apparatus which can communicate with an image processing apparatus via a network, the method comprising:
receiving update information of firmware from the image processing apparatus;
determining whether virtual config data needs to be updated based on the received update information;
generating the virtual config data, when the determining determines that the virtual config data needs to be updated;
notifying the image processing apparatus of necessity information indicating that the virtual config data needs to be updated, when the determining determines that the virtual config data needs to be updated; and
registering the generated virtual config data.

9. A non-transitory computer-readable storage medium storing a computer program for causing a computer to execute the information processing method according to claim 7.

10. A non-transitory computer-readable storage medium storing a computer program for causing a computer to execute the information processing method according to claim 8.
